(19) United States
(12) Patent Application Publication
(10) Pub. No.: US 2009/0102093 A1
(43) Pub. Date: Apr. 23, 2009

(54) METHOD OF SEALING AND MOLDING ELECTRONIC COMPONENT WITH RESIN AND MOLD

(76) Inventors: Hideki TOKUYAMA, Kyoto-shi (JP); Yohei ONISHI, Kyoto-shi (JP)

Correspondence Address: BIRCH STEWART KOLASCH & BIRCH, PO BOX 747, FALLS CHURCH, VA, 22040-0747, US

(21) Appl. No.: 12/247,080

(22) Filed: Oct. 7, 2008

(30) Foreign Application Priority Data
Oct. 17, 2007 (JP) 2007-270216(P)

(51) Int. Cl. B29C 45/14; B29C 45/03

(52) U.S. Cl. 264/259; 425/556

(57) ABSTRACT

A molded product (consisting of resin compact and substrate) is formed by sealing and molding an electronic component mounted on a substrate in a resin compact by injecting/charging a heated/molten resin material into a cavity. Then, when a pressing member presses an ejector plate urged in a return direction (downward) in an ejective direction (upward) through a presser, a return pin guides mold releasing pins fixedly provided on the ejector plate, thereby ejecting and releasing the molded product from a mold with the mold releasing pins. Upon defective sliding of the mold releasing pins, the mold releasing pins can be returned to return positions by pressing the return pin with an upper mold section.

This nonprovisional application is based on Japanese Patent Application No. 2007-270216 filed on Oct. 17, 2007 with the Japan Patent Office, the entire contents of which are hereby incorporated by reference.

### BACKGROUND OF THE INVENTION

1. Field of the Invention

The present invention relates to improvements in a method of sealing and molding an electronic component with resin for sealing and molding an electronic component such as an IC mounted on a substrate, for example, with a resin material and a mold.

2. Description of the Background Art

In general, a three-plate mold consisting of a fixed upper mold section, an intermediate mold section (cavity plate) and a movable lower mold section for sealing and molding an electronic component with resin is employed for molding a sealed substrate (molded product) by resin-sealing (single-molding) an electronic component mounted on a substrate by transfer molding utilizing a top gate.

First, the three-plate mold (mold) is heated to a prescribed temperature, the substrate mounted with the electronic component is set in the mold in the state directing the surface mounted with the electronic component downward, and the three-plate mold is thereafter closed, thereby setting the electronic component mounted on the substrate in an intermediate mold cavity for molding (resin molding) provided on a mold surface of the intermediate mold section closer to the upper mold section.

Then, a resin material heated/molten in a pot of the lower mold section is pressurized with a plunger for resin pressurization, thereby injecting/charging molten resin into the cavity through a runner for resin transfer provided on a mold surface of the lower mold section and a top gate (sprue) for resin injection provided on the intermediate mold section.

After a lapse of a time necessary for curing the resin, the mold is opened, thereby resin-sealing the electronic component mounted on the substrate in a resin compact corresponding to the shape of the cavity in the cavity and molding a sealed substrate (molded product).

At this time, cured resin unnecessary for the molded product (product) is formed in a resin passage formed by at least the gate and the runner.

Therefore, the lower mold section is thereafter moved downward while the cured resin adheres to the runner provided on the mold surface of the lower mold section and the mold is opened at least between the lower mold section and the intermediate mold section, thereby cutting/separating the resin compact provided in the cavity and the cured resin provided in the gate from each other along the joint therebetween. Further, the resin compact and the substrate are simultaneously ejected and released from the cavity and the mold surface of the intermediate mold section respectively with mold releasing pins.

FIG. 10 shows a mold releasing mechanism for a mold generally employed for ejecting and releasing a resin compact from a cavity of an intermediate mold section.

In the mold (intermediate mold section 101) shown in FIG. 10, the mechanism for ejecting and releasing a molded product 110 (consisting of a resin compact 103 and a substrate 104) from the mold (including a cavity 102) is constituted of mold releasing pins 105 provided on intermediate mold section 101, compression springs 106 urging mold releasing pins 105 downward for returning the forward ends thereof to return positions (positions on a mold surface 101a of intermediate mold section 101 or on the bottom surface 102a of cavity 102) and pressing members 107 provided on a lower mold section for serving as driving sources.

Therefore, pressing members 107 provided on the lower mold section for serving as driving sources are driven upward for moving mold releasing pins 106 upward, thereby ejecting and releasing molded product 110 (consisting of resin compact 103 and substrate 104) from intermediate mold section 101 (including cavity 102).

In the mold (intermediate mold section 101) provided with the aforementioned mold releasing mechanism as shown in FIG. 10, however, any mold releasing pin 105 may cause defective sliding and remains unreturned although compression spring 106 is provided for returning the forward end of corresponding mold releasing pin 105 to the return position thereof, to stop in a state protruding from mold surface 101a of intermediate mold section 101 closer to an upper mold section 108 or bottom surface 102a of cavity 102.

Therefore, a method of sealing and molding an electronic component with resin and a mold capable of efficiently returning mold releasing pins 105 to the return positions thereof in normal molding with the mold are demanded.

When upper mold section 108 and intermediate mold section 101 are closed upon defective sliding of mold releasing pin 105 as shown in FIG. 10, mold releasing pin 105 stopping in the state protruding from mold surface 101a is bent (or broken) due to the mold surface of upper mold 108 (substantially the surface of substrate 104 set on a substrate supply portion 109 of upper mold section 108) on mold surface 101a of intermediate mold section 101 closer to upper mold section 108, for example, to form a bent portion 105a. Thus, the mold itself gets out of order, and hence the productivity of molded product 110 (product) is reduced and cannot be efficiently improved.

When upper mold section 108 and intermediate mold section 101 are closed as shown in FIG. 10, a hole 103a is formed in resin compact 103 molded in cavity 102, for example, to result in defective appearance. Therefore, the productivity of molded product 110 (product) molded in the mold is reduced and cannot be efficiently improved.

Therefore a method of sealing and molding an electronic component with resin and a mold capable of efficiently returning mold releasing pins to return positions thereof upon defective sliding of the mold releasing pins are demanded.

When any mold releasing pin 105 remains unreturned (upon defective sliding of mold releasing pin 105), the molding with the mold must be stopped for returning mold releasing pin 105 to the return position, and hence the productivity of molded product 110 (product) molded in the mold is reduced and cannot be efficiently improved.

Therefore, a method of sealing and molding an electronic component with resin and a mold capable of efficiently returning mold releasing pins to return positions thereof in normal molding with the mold or upon defective sliding of the mold releasing pins and efficiently improving the productivity of products are demanded.

### SUMMARY OF THE INVENTION

An object of the present invention is to provide a method of sealing and molding an electronic component with resin and a mold capable of efficiently returning mold releasing pins to return positions thereof in normal molding with the mold or upon defective sliding of the mold releasing pins.

Another object of the present invention is to provide a method of sealing and molding an electronic component with resin and a mold capable of efficiently returning mold releasing pins to return positions thereof in normal molding with the mold or upon defective sliding of the mold releasing pins and efficiently improving the productivity of products.

In place of the aforementioned structure (prior art), a mold prepared by surface-treating a cavity surface and a mold surface of an intermediate mold section closer to an upper mold section with a mold releasing agent such as Teflon (registered trademark), for example, has been examined.

When the mold surface-treated with the mold releasing agent is employed, however, a molded product (consisting of a resin compact and a substrate) cannot be regularly efficiently released from the mold.

A method of sealing and molding an electronic component with resin according to the present invention for solving the aforementioned technical problems is a method of sealing and molding an electronic component with resin for forming a molded product by sealing and molding an electronic component mounted on a substrate with a mold for sealing and molding an electronic component with resin consisting of a first mold section, a second mold section and an intermediate mold section provided between the first and second mold sections by injecting and charging a heated and molten resin material into a cavity for resin molding provided in the aforementioned intermediate mold section. This method comprises the following steps: Necessary portions of the molded product are ejected and released from the mold with a necessary number of mold releasing pins fixedly set on an ejector plate provided on the intermediate mold section and urged toward the second mold section by pressing the ejector plate with a pressing member provided on the second mold section through a presser provided on the intermediate mold section in molding with the aforementioned mold. The pressing with the pressing member is canceled in the molding with the mold, thereby elastically urging the ejector plate and returning the ejector plate to a return position. The mold releasing pins are guided in a protrusive or returned direction with a return pin fixedly provided on the ejector plate in the molding with the mold.

The method of sealing and molding an electronic component with resin according to the present invention for solving the aforementioned technical problems further includes the step of returning the mold releasing pins to return positions by pressing the return pin with the first mold section upon defective sliding of the mold releasing pins.

A mold for sealing and molding an electronic component with resin according to the present invention for solving the aforementioned technical problems is a mold for sealing and molding an electronic component with resin, including a first mold section, a second mold section opposed to the first mold section, an intermediate mold section provided between the first and second mold sections and a cavity for resin molding provided on a mold surface of the intermediate mold section closer to the first mold section, including an ejector plate provided at the intermediate mold section, a necessary number of mold releasing pins fixedly provided at the ejector plate, a presser provided at the intermediate mold section for pressing the ejector plate in an ejective direction, a pressing member provided at the second mold section for pressing the ejector plate through the presser, an elastic member returning the mold releasing pins to return positions, another elastic member returning the ejector plate to a return position and a return pin guiding the ejector plate and the mold releasing pins in a protrusive or returned direction.

According to the aforementioned structure, a protrusive/returned operation of the mold releasing pins (ejector plate) can be efficiently regulated in a necessary direction (protrusive/returned direction) with the return pin (guide member) sliding in a sliding hole of the intermediate mold section in normal molding with the mold (top gate) for sealing and molding an electronic component with resin. Therefore, the mold releasing pins can be stably guided in the protrusive/returned direction (vertical direction in the accompanying drawings).

In ejection with the mold releasing pins, therefore, the necessary portions of the molded product can be efficiently ejected with the mold releasing pins and the mold releasing pins can be efficiently returned to the return positions thereof due to the guiding action of the return pin.

Upon defective sliding of the mold releasing pins, the mold releasing pins (ejector plate) can be efficiently returned to the return positions thereof by pressing the return pin with the first mold section.

According to the present invention, therefore, a method of sealing and molding an electronic component with resin and a mold capable of efficiently returning mold releasing pins to return positions thereof in normal molding with the mold or upon defective sliding of the mold releasing pins can be provided.

According to the present invention, further, a method of sealing and molding an electronic component with resin and a mold capable of efficiently returning mold releasing pins to return positions thereof and efficiently improving productivity of products in normal molding with the mold or upon defective sliding of the mold releasing pins can be provided.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic longitudinal sectional view schematically showing a mold for sealing and molding an electronic component with resin according to the present invention in an open state;

FIG. 2 is a schematic longitudinal sectional view schematically showing the mold of FIG. 1 in a closed state (for injecting resin into a mold cavity);

FIG. 3 is a schematic longitudinal sectional view schematically showing the mold of FIG. 1 in a state of cutting top gate resin from a resin compact;

FIG. 4 is a schematic longitudinal sectional view schematically showing the mold of FIG. 1 in a state of ejecting and releasing a molded product (consisting of the resin compact and a substrate) from the mold cavity;

FIG. 5 is a schematic longitudinal sectional view schematically showing the mold of FIG. 1 in another state of releasing the molded product from the mold cavity;

FIGS. 6A and 6B are schematic enlarged longitudinal sectional views schematically showing the mold of FIG. 1 in an enlarged manner, for illustrating a defective sliding state of a mold releasing pin and a state of pressing down the mold releasing pin by pressing down a return pin with an upper mold section;

FIG. 7A is a schematic plan view schematically showing an ejector plate provided on the mold shown in FIG. 1, FIG. 7B is a schematic plan view schematically showing a mold surface of a mold section (intermediate mold section), provided with the ejector plate shown in FIG. 7A, closer to the upper mold section, and FIG. 7C is a schematic perspective view schematically showing a molded product molded in the mold shown in FIG. 7B;

FIG. 8A is a schematic plan view schematically showing an ejector plate provided on another mold according to the present invention, FIG. 8B is a schematic plan view schematically showing a mold surface of a mold section (intermediate mold section), provided with the ejector plate shown in FIG. 8A, closer to an upper mold section, and FIG. 8C is a schematic perspective view schematically showing a molded product molded in the mold shown in FIG. 8B;

FIG. 9A is a schematic enlarged cross sectional view schematically showing the mold shown in FIG. 2 in an enlarged manner, and FIG. 9B is a schematic enlarged cross sectional view schematically showing the mold shown in FIG. 4 in an enlarged manner; and

FIG. 10 is a schematic longitudinal sectional view schematically showing a conventional mold (mainly an intermediate mold section comprising mold releasing pins) for sealing and molding an electronic component with resin.

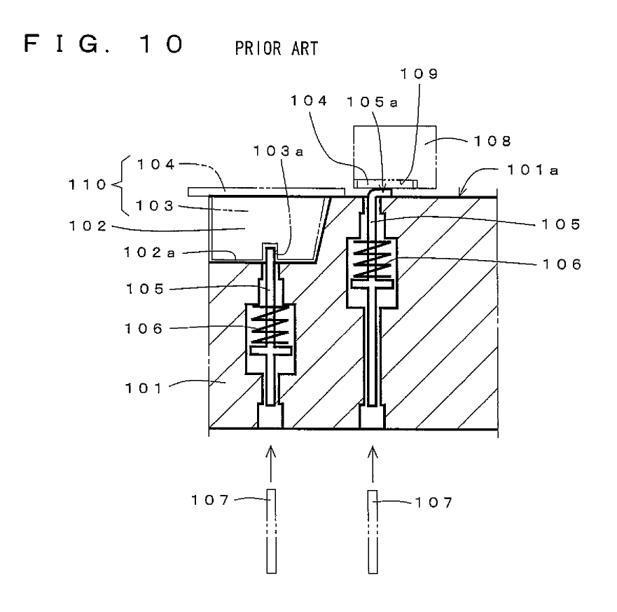

### DESCRIPTION OF THE PREFERRED EMBODIMENTS

The present invention is now described in detail with reference to the accompanying drawings.

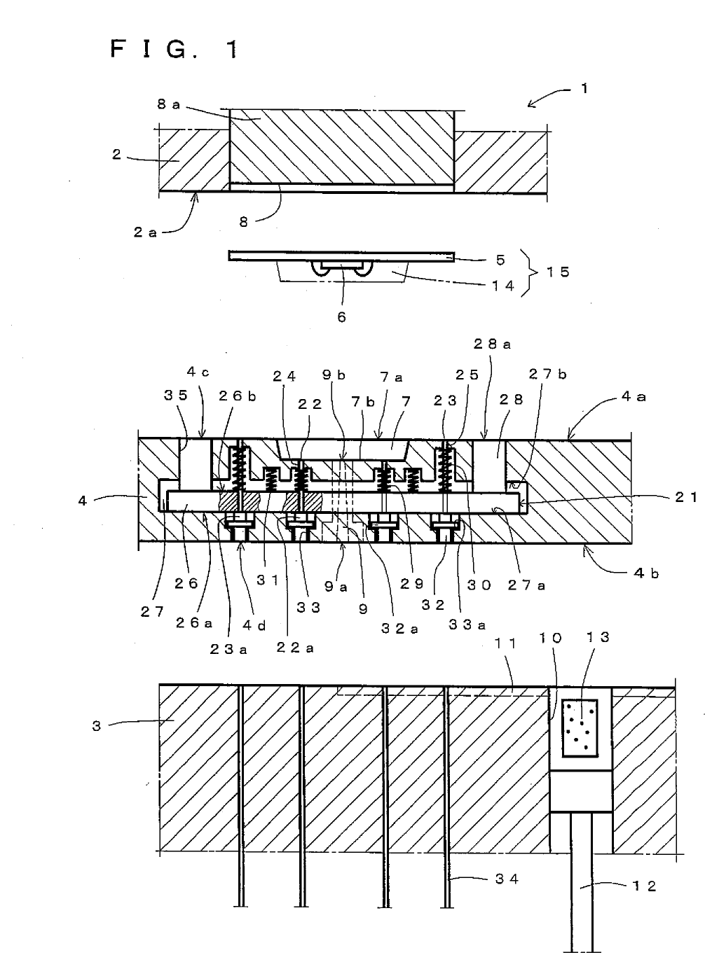

FIGS. 1, 2, 3, 4, 5, 6A and 6B illustrate a mold (top gate system) for sealing and molding an electronic component with resin according to the present invention.

According to the present invention, mold releasing pins, an ejector plate, return pins (guide members) and return means (elastic members) for the mold releasing pins are provided in an ejector space portion (engraved portion) of an intermediate mold section, while pressing members driving the mold releasing pins (ejector plate) in an ejective direction are provided on a lower mold section, as described later.

In other words, the return pins (guide members) efficiently guide the mold releasing pins (ejector plate) in a protrusive/returned direction in normal molding with the mold, thereby efficiently preventing the mold releasing pins from defective sliding.

Upon defective sliding of the mold releasing pins, the mold releasing pins are efficiently returned to return positions by pressing the return pins.

[Structure of Mold for Sealing and Molding Electronic Component With Resin]

As shown in the drawings, a mold 1 for sealing and molding an electronic component with resin according to the present invention is constituted of a fixed upper mold section 2, a movable lower mold section 3 opposed to upper mold section 2 and a movable intermediate mold section 4 (cavity plate) vertically movably provided between upper and lower mold sections 2 and 3.

In mold 1 according to the present invention, lower mold section 3 is first moved upward, thereby combining lower mold section 3 and intermediate mold section 4 with each other. Then, lower mold section 3 and intermediate mold section 4 are moved upward in the combined state, so that mold 1 can be closed by combining upper, intermediate and lower mold sections (three plates) 2, 3 and 4 with each other.

Heating means (not shown) for heating mold 1 to a prescribed temperature is properly provided with respect to upper, intermediate and lower mold sections (three plates) 2, 3 and 4.

An intermediate mold cavity 7 for molding (resin-molding) a molded product by fitting and setting an electronic component 6 mounted on a substrate 5 is provided on a mold surface 4a of intermediate mold section 4 closer to upper mold section 2, with an upward opening 7a.

A substrate supply portion 8 (recess) capable of supplying and setting substrate 5 mounted with electronic component 6 in a state directing the surface mounted with electronic component 6 downward is provided on a mold surface 2a of upper mold section 2.

As shown in the drawings, a fixing member 8a adjustable (vertically movable) in response to the thickness of substrate 5 for pressing substrate 5 downward and fixing the same to mold surface 4a (around opening 7a of cavity 7) of intermediate mold section 4 closer to upper mold section 2 is provided on a substrate set side (bottom surface of the recess) of substrate supply portion 8.

Electronic component 6 mounted on substrate 5 can be fitted and set in cavity 7 by supplying and setting substrate 5 mounted with electronic component 6 to and on substrate supply portion 8 of upper mold section 2 in the state directing the surface mounted with electronic component 6 downward and closing upper and intermediate mold sections 2 and 3.

Substrate supply portion 8 may be formed by mold surface (not a recess but a plane) 2a of upper mold section 2.

In the case of substrate 5 mounted with electronic component 6 according to the present invention, the depth of cavity 7 (distance between cavity opening 7a and a cavity bottom surface 7b) may be set to not more than 1 mm, for example.

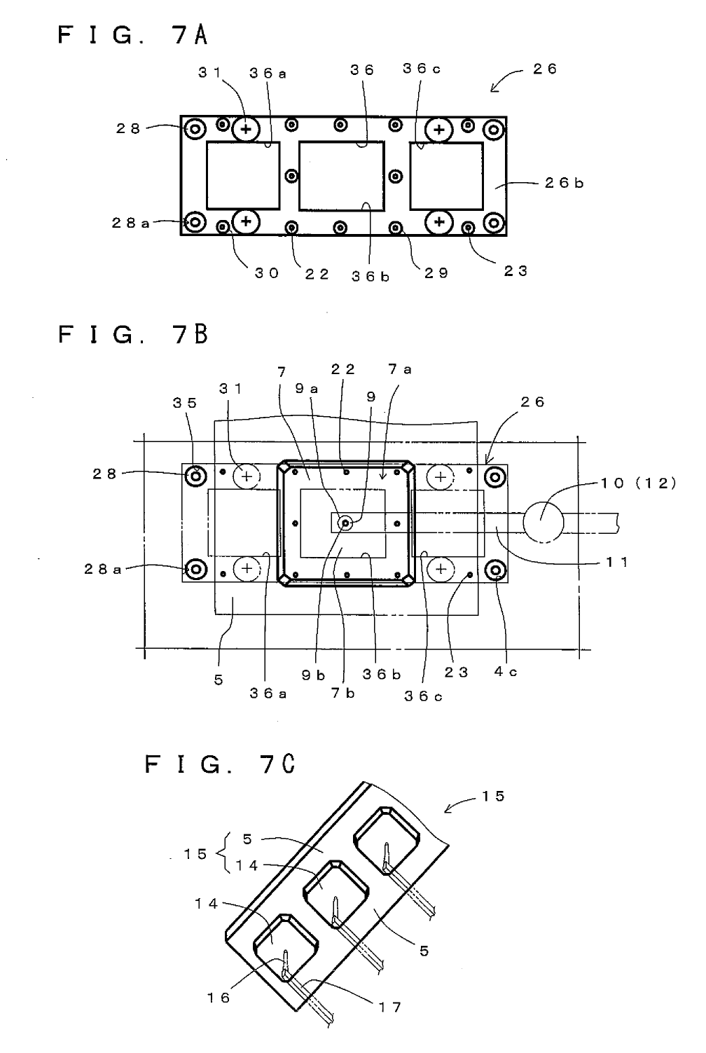

A top gate (sprue) 9 for resin injection injecting a heated/molten resin material 13 into cavity 7 is provided on another mold surface 4b of intermediate mold section 4 closer to lower mold section 3 in a state having a gate opening 9a. A gate inlet 9b of gate 9 is provided in a state communicatively connected with the center of cavity bottom surface 7b of cavity 7 (see FIG. 7B).

A pot 10 for supplying resin material 13 and a runner (groove portion) 11 for resin transfer communicatively connected with pot 10 are provided on a mold surface of lower mold section 3 in states opening independently of each other. A plunger 12 for resin pressurization is vertically slidably provided in pot 10.

Lower mold section 3 and intermediate mold section 4 are so closed as to communicatively connect opening 9a of gate 9 and runner (groove portion) 11 with each other. Further, pot 10 and cavity 7 can be communicatively connected with each other through a resin passage formed by gate 9 (opening 9a and inlet 9b) and runner 11.

Resin material 13 is supplied into and heated/molten in pot 10 of lower mold section 3 and heated/molten resin material 13 is pressurized with plunger 12, so that resin material 13 can be injected/charged into cavity 7 from gate inlet 9b through the resin passage formed by gate 9 (opening 9a and inlet 9b) and runner 11.

Therefore, electronic component 6 mounted on substrate 5 can be sealed/molded in resin compact 14 corresponding to the shape of cavity 7, to obtain a molded product 15 (consisting of resin compact 14 and substrate 5).

[Structure of Molded Product Releasing Mechanism in Intermediate Mold Section]

(Structures of Mold Releasing Pin and Ejector Plate)

As shown in the drawings, intermediate mold section 4 is provided with a molded product releasing mechanism 21 ejecting and releasing molded product 15 (consisting of resin compact 14 and substrate 5).

Molded product releasing mechanism 21 is provided with mold releasing pins 22 for ejecting and releasing resin-molded compact 14 solidified in cavity 7 and mold releasing pins 23 for ejecting and releasing substrate 5, as means for ejecting and releasing molded product 15 from mold 1. Intermediate mold section 4 is provided with fitting holes 24 corresponding to mold releasing pins 22 for releasing resin compact 14 and fitting holes 25 corresponding to mold releasing pins 23 for releasing substrate 5 respectively.

Mold releasing pins 22 and 23 are fixedly provided in states individually passing through an ejector plate 26 (see FIG. 7A). Ejector plate 26 is freely fitted in an ejector space portion (engraved portion) 27 formed by engraving intermediate mold section 4 correspondingly to the shape of ejector plate 26 in a vertically movable manner.

Heads 22a forming base ends of mold releasing pins 22 passing through ejector plate 26 are fixed to a lower surface 26a of ejector plate 26. Heads 23a forming base ends of mold releasing pins 23 passing through ejector plate 26 are also fixed to lower surface 26a of ejector plate 26.

Heads 22a and 23a individually having necessary thicknesses protrude from lower surface 26a of ejector plate 26 (as protrusions).

As described later, heads 22a and 23a forming the base ends of mold releasing pins 22 and 23 are stored in stop sliding holes 33 of pressers 32. Pressers 32 can press heads 22a and 23a of mold releasing pins 22 and 23 upward (in the ejective direction for mold releasing pins 22 and 23) by moving in stop sliding holes 33 upward.

In other words, heads 22a and 22a of mold releasing pins 22 and 23 serve as pressing portions for moving ejector plate 26 upward with pressers 32.

Ejector plate 26 is moved upward in ejector space portion 27 for moving mold releasing pins 22 and 23 upward, so that resin compact 14 can be ejected and released from bottom surface 7b of cavity 7 with mold releasing pins 22 and substrate 5 can be pushed up and released from mold surface 4a of intermediate mold section 4 closer to upper mold section 2 with mold releasing pins 23.

Before the resin sealing and molding, mold releasing pins 22 and 23 and ejector plate 26 are located on return positions (initial positions) in general.

The forward ends of mold releasing pins 22 for releasing resin compact 14 are arranged on bottom surface 7b of cavity 7, mold releasing pins 23 for releasing substrate 5 are arranged on mold surface 4a of intermediate mold section 4 closer to upper mold section 2, and ejector plate 26 is arranged in a state bonding lower surface 26a thereof to a lower surface 27a of ejector plate space portion 27 respectively.

In ejection with mold releasing pins 22 and 23, the forward ends of mold releasing pins 22 for releasing resin compact 14 are arranged on positions protruding from bottom surface 7b of cavity 7, mold releasing pins 23 for releasing substrate 5 are arranged on positions protruding from mold surface 4a of intermediate mold section 4 closer to upper mold section 2, and ejector plate 26 is arranged in a state bonding an upper surface 26b thereof to an upper surface 27b of ejector plate space portion 27 respectively.

As to ejector plate 26, space portion 27 having the minimum necessary mold releasing means may be provided in the present invention, and hence ejector plate 26 can be worked into a shape different from a generally employed flat shape.

(Structure of Return Pin)

Return pins 28 are fixedly provided on ejector plate 26. Return pins 28 and ejector plate 26 (mold releasing pins 22 and 23) vertically move integrally with each other.

In the example shown in FIG. 7A, return pins 28 are provided on for corners of ejector plate 26 rectangular in plan view respectively, as described later.

Return pins 28 are vertically slidable in return pin sliding holes 35 provided in intermediate mold section 4 with openings 4c in mold surface 4a of intermediate mold section 4 closer to upper mold section 2.

The positions of forward end surfaces 28a of return pins 28 and those of the forward ends of mold releasing pins 23 for releasing substrate 5 coincide with each other.

Overall ejector plate 26 fixedly provided with return pins 28 can be efficiently and stably vertically moved (driven in the protrusive return direction for mold releasing pins 22 and 23) in a parallelly held state without inclination by sliding return pins 28 in sliding holes 35.

Therefore, return pins 28 function as guide means efficiently and stably guiding (vertically moving) ejector plate 26 in the protrusive return direction for mold releasing pins 22 and 23 in normal operations of mold releasing pins 22 and 23. Thus, mold releasing pins 22 and 23 can be efficiently prevented from defective sliding.

Return pins 28 also function as return means for returning mold releasing pins 22 and 23 (ejector plate 26) to the return positions when mold releasing pins 22 and 23 cause defective sliding. Return pins 28 guide ejector plate 26 when efficiently and stably moving overall ejector plate 26 downward toward the return position in the state parallelly holding ejector plate 26 without inclination, as a matter of course.

When mold releasing pins 22 and 23 cause defective sliding as described later, therefore, mold releasing pins 22 and 23 can be moved downward and returned to the return positions through ejector plate 26 by relatively downwardly pressing and moving forward end surfaces 28a of return pins 28 with mold surface 2a of upper mold 2.

When mold releasing pins 22 and 23 are returned to the return positions thereof, forward end surfaces 28a of return pins 28 are located on mold surface 4a of intermediate mold section 4 closer to upper mold section 2 (return positions).

(Structure of Returning/Driving Means)

First elastic members 29 such as compression springs are provided around shafts of mold releasing pins 22 (on the positions of mold releasing pins 22) as returning/driving means elastically urging mold releasing pins 22 (and ejector plate 26) in a direction (return direction) opposite to the ejective direction and returning the same to the return positions.

Second elastic members 30 such as compression springs are also provided around shafts of mold releasing pins 23 (on the positions of mold releasing pins 23) as returning/driving means, similarly to first elastic members 29 for mold releasing pins 22.

Ejector plate 26 itself is provided with third elastic members 31 such as compression springs as returning/driving means elastically urging ejector plate 26 in the direction opposite to the ejective direction for mold releasing pins 22 and 23 and returning the same to the return position.

First, second and third elastic members 29, 30 and 31 can elastically press mold releasing pins 22 and 23 and ejector plate 26 downward (in the return direction opposite to the ejective direction for mold releasing pins 22 and 23), thereby individually locating mold releasing pins 22 and 23 and ejector plate 26 on the return positions thereof.

At this time, the forward ends of mold releasing pins 22 for releasing resin compact 14 can be returned to bottom surface 7b of cavity 7, the forward ends of mold releasing pins 23 for releasing substrate 5 can be returned to mold surface 4a of intermediate mold section 4 closer to upper mold section 2, and lower surface 26a of ejector plate 26 can be returned to the state bonded to lower surface 27a of ejector plate space portion 27 respectively, as hereinabove described.

(Structure of Presser)

As hereinabove described, mold releasing pins 22 and 23 passing through ejector plate 26 are fixedly provided on lower surface 26a of ejector plate 26 at heads (protrusions) 22a and 23a having the necessary thicknesses.

Further, pressers (pressing components) 32 vertically moving and pressing ejector plate 26 (mold releasing pins 22 and 23) and stop sliding holes 33 so formed that pressers 32 slide therein with stop step portions 33a stopping pressers 32 are provided on lower surface 27a of ejector space portion 27 of intermediate mold section 4 under heads (protrusions) 22a and 23a.

Stop sliding holes 33 have openings 4d in mold surface 4b of intermediate mold section 4 closer to lower mold section 3.

Flange portions 32a for preventing dropping of pressers 32 and pressing ejector plate 26 are provided on the forward ends (upper ends) of pressers 32, and stop step portions 33a of stop sliding holes 33 can stop flange portions 32a. Upper surfaces of flange portions 32a are formed by planes having relatively wide areas.

Therefore, pressers 32 can vertically slide in stop sliding holes 33, and can be stopped by engaging flange portions 32a with stop step portions 33a.

At least pressers 32 are so formed as not to go out from stop sliding holes 33 into ejector space portion 27.

Heads (protrusions) 22a and 23a of mold releasing pins 22 and 23 are stored in corresponding stop sliding holes 33 when mold releasing pins 22 and 23 are returned to the return positions.

At this time, heads (protrusions) 22a and 23a may be bonded to or separated from pressers 32 (flange portions 32a).

Pressing members 34 described later are so pressed upward that pressers 32 can be moved upward by pushing up the base ends (lower ends) of pressers 32 (through openings 4d of stop sliding holes 33).

When this pressing with pressing members 34 is canceled, pressers 32 fall by the own weights thereof, and can be stopped in stop sliding holes 33 by stopping flange portions 32a by stop step portions 33a.

In other words, necessary portions on lower surface 26a of ejector plate 26 (i.e., heads 22a and 23a of mold releasing pins 22 and 23) can be pressed by moving pressers 32 upward.

Therefore, overall ejector plate 26 can be pressed in the ejective direction for mold releasing pins 22 and 23 with the necessary number of pressers 32 (pressing members 34).

As hereinabove described, molded product releasing mechanism 21 provided on intermediate mold section 4 is constituted of mold releasing pins 22 and 23, ejector plate 26, return pins 28, first, second and third elastic members 29, 30 and 31 and pressers 32.

### (Driving Means for Molded Product Releasing Mechanism on Lower Mold Section)

Lower mold section 3 is provided with pressing members (pressing pins) 34 pressing ejector plate 26 upward (in the ejective direction for mold releasing pins 22 and 23) through pressers 32 against elastic pressures by first, second and third elastic members 29, 30 and 31 as driving means (pressing means) for molded product releasing mechanism 21.

Ejector plate 26 can be moved upward by moving pressing members 34 upward thereby moving pressers 32 in stop sliding holes 33 upward, whereby molded product 15 can be ejected and released by moving mold releasing pins 22 and 23 fixedly provided on ejector plate 26 upward.

In other words, overall ejector plate 26 can be moved/pressed upward in the ejective direction for mold releasing pins 22 and 23 with pressing members 34 through pressers 32 by individually moving/pressing pressers 32 upward with pressing members 34.

At this time, mold releasing pins 22 for releasing resin compact 14 protrude from cavity bottom surface 7b in cavity 7 while mold releasing pins 23 for releasing substrate 5 protrude from mold surface 4a of intermediate mold section 4 closer to upper mold section 2, as hereinabove described.

At this time, further, return pins 28 move (upward) in the ejective direction similarly to mold releasing pins 22 and 23, 50 that forward end surfaces 28a thereof protrude above mold surface 4a of intermediate mold section 4 loser to upper mold section 2 (above openings 4c of sliding holes 35), as hereinabove described.

At this time, in addition, upper surface 26b of ejector plate 26 is bonded to upper surface 27b of ejector space portion 27 in ejector space portion 27 of intermediate mold section 4, as hereinabove described.

The pressing with pressing members 34 is so canceled that first, second and third elastic members 29, 30 and 31 can elastically press ejector plate 26 downward (in the return direction). Thus, the forward ends of mold releasing pins 22 and 23 and forward end surfaces 28a of return pins 28 can be returned to the return positions (original positions).

In other words, the forward ends of mold releasing pins 22 for releasing resin compact 14 can be returned to bottom surface 7b of cavity 7, the forward ends of mold releasing pins 23 for releasing substrate 5 can be returned to mold surface 4a of intermediate mold section 4 closer to upper mold section 2 and forward end surfaces 28a of return pins 28 can be returned to mold surface 4a of intermediate mold section 4 closer to upper mold section 2, due to the aforementioned elastic pressing actions of first, second and third elastic members 29, 30 and 31.

In the pressing with pressing members 34 and cancellation thereof, return pins 28 can efficiently and stably guide overall ejector plate 26 in the protrusive return direction (vertical direction) for mold releasing pins 22 and 23.

(Upon Defective Sliding of Mold Releasing Pin)

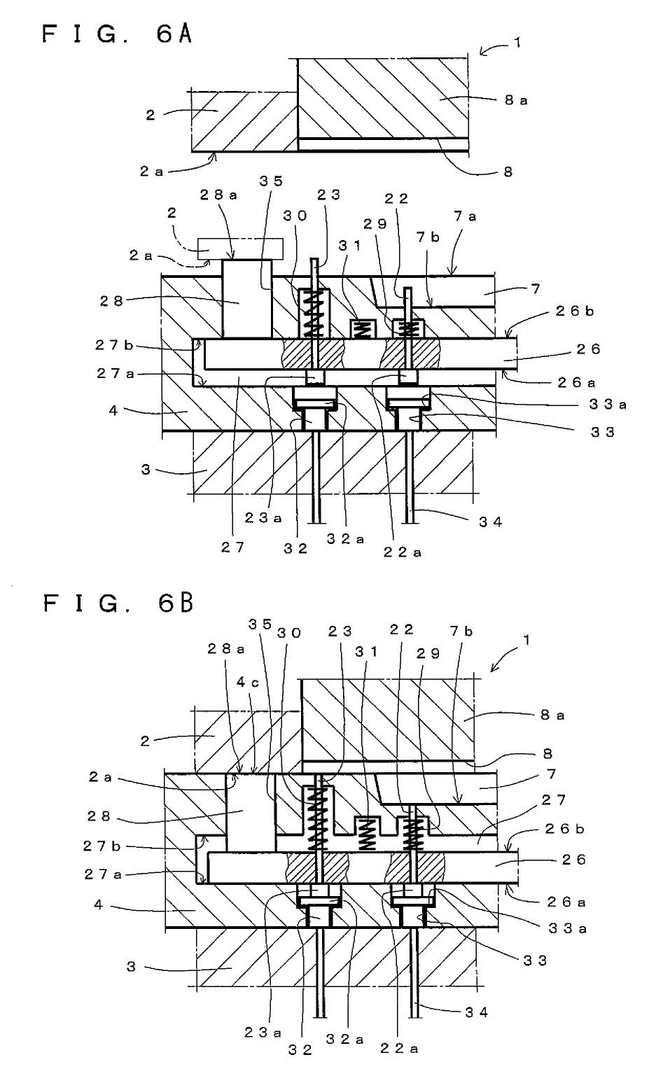

If mold releasing pins 22 and 23 cause defective sliding and ejector plate 26 (mold releasing pins 22 and 23) cannot be slid downward by the elastic pressing actions of first, second and third elastic members 29, 30 and 31 as shown in FIG. 6A, for example, forward end surface 28a of each return pin 28 can be returned to mold surface 4a of intermediate mold section 4 closer to upper mold section 2 by pressing forward end surface 28a of return pin 28 with mold surface 2a of upper mold section 2 (by relatively moving upper mold section 2 downward), as shown in FIG. 6B.

At this time, mold releasing pins 22 and 23 and ejector plate 26 are moved downward integrally with return pin 28, whereby the forward ends of mold releasing pins 22 and 23 can be returned to the return positions.

In other words, the forward ends of mold releasing pins 23 for releasing substrate 5 (or mold releasing pins 22 for releasing resin compact 14) can be efficiently returned to the return positions thereof by pressing forward end surfaces 28a of return pins 28 with mold surface 2a of upper mold section 2 according to the present invention, whereby mold releasing pins 23 for releasing substrate 5 can be efficiently prevented from being bent or broken on mold surface 2a of upper mold section 2 (surface of substrate 5).

Therefore, mold releasing pins 22 and 23 can be efficiently returned to the return positions even if the same cause defective sliding.

Further, mold releasing pins 22 and 23 can be so efficiently returned to the return positions that the productivity of molded product 15 (product) can be efficiently improved.

(Structure of Ejector Plate)

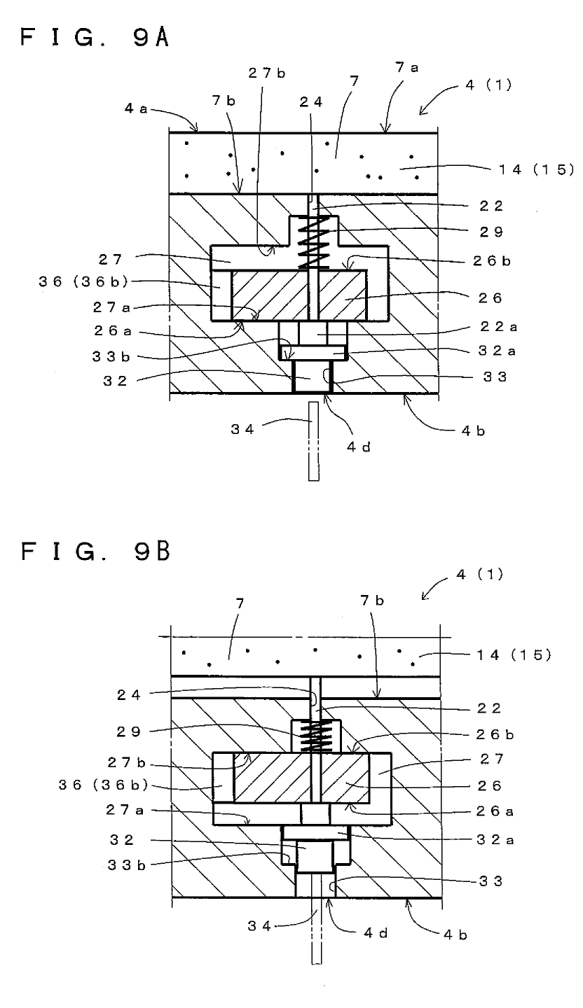

The structure of ejector plate 26 is described with reference to FIGS. 7A to 7C and 9A and 9B.

FIG. 7A shows rectangular ejector plate 26 employed for mold 1 (2, 3 and 4) for sealing and molding electronic component 6 with resin, and FIG. 7B shows mold surface 4a of intermediate mold section 4 (cavity plate), provided with ejector plate 26, closer to upper mold section 2, while illustrating ejector plate 26 with two-dot chain lines.

FIG. 7C shows a molded product 15 (consisting of substrate 5 and resin compacts 14) sealed/molded with resin in mold 1 (intermediate mold section 4), along with top gate resin 16 and runner resin 17.

FIGS. 9A and 9B show each mold releasing pin 22 for releasing resin compact 14 fixedly provided on ejector plate 26 while passing through the same. FIG. 9A shows a state before ejection of resin compact 14 with mold releasing pin 22, and FIG. 9B shows a state of ejecting resin compact 14 with mold releasing pin 22.

As shown in FIG. 7A, ejector plate 26 is provided with rectangular through-holes (volume reducing portions) 36 for reducing the volume thereof. Referring to FIG. 7A, three through-holes 36 (a left through-hole 36a, a central through-hole 36b and a right through-hole 36c) are serially provided successively from the left side.

As shown in FIG. 7B, central through-hole 36b of ejector plate 26 is provided correspondingly to the position (gate inlet 9b) of top gate 9 provided on bottom surface 7b of cavity 7 of intermediate mold section 4, for freely fitting ejector plate 26 in a mold member comprising top gate 9.

As shown in FIGS. 7A and 7B, mold releasing pins 22 for releasing resin compact 14 are provided on necessary portions (around central through-hole 36b in FIGS. 7A and 7B) corresponding to the position of cavity 7 (cavity opening 7a) provided on mold surface 4a of intermediate mold section 4 closer to upper mold section 2 on upper surface 26b of ejector plate 26, while first elastic members 29 are circumferentially provided on the positions of mold releasing pins 22 (shafts).

Further, mold releasing pins 23 for releasing substrate 5 are provided on necessary portions (around left through-hole 36a or right through-hole 36c) corresponding to the position of substrate 5 (position of substrate supply portion 8 of upper mold section 2) arranged on mold surface 4a of intermediate mold section 4 while second elastic members 30 are circumferentially provided on the positions of mold releasing pins 23 (shafts) on upper surface 26b of ejector plate 26.

In addition, return pins 28 are provided on four corners of mold surface 4a of intermediate mold section 4 outside the position of substrate 5 on upper surface 26b of ejector plate 26. Third elastic members 31 are provided between the position of cavity 7 and the positions of mold releasing pins 23 on mold surface 4a of intermediate mold section 4 (around through-holes 36).

In the drawings, ejector plate 26 is provided with eight mold releasing pins 22 (first elastic members 29), four mold releasing pins 23 (second elastic members 30), four return pins 28 and four third elastic members 31.

Referring to FIG. 7B, pot 10 is located on the right side of right through-hole 36c, and runner 11 is arranged across right through-hole 36c and central through-hole 36b.

Ejector space portion 27 for freely fitting with ejector plate 26 is formed by engraving intermediate mold section 4 correspondingly to the shape of ejector plate 26, and the mold member is freely fitted in through-holes 36.

While a general ejector plate is in the form of a flat plate, mold 1 (particularly intermediate mold section 4 itself) equipped with ejector plate 26 according to the present invention is small-sized and hence ejector space portion 27 must be set to the minimum necessary size.

Therefore, ejector plate 26 is formed in an irregular shape, having through-holes 36 etc., different from the flat shape. Ejector plate 26 is provided with through-holes 36 while the thickness thereof is reduced to about half the general level, thereby reducing the volume of ejector plate 26 to the minimum necessary level and reducing the engraved portion (ejector space portion 27) for receiving ejector plate 26 having the irregular shape to the minimum necessary size.

As shown in FIGS. 9A and 9B, each mold releasing pin 22 ejecting and releasing resin compact 14 obtained by sealing and molding electronic component 6 mounted on substrate 5 in cavity 7, for example, is fixedly provided on ejector plate 26 while passing through the same. Ejector plate 26 is freely fitted in ejector space portion (engraved portion) 27 obtained by engraving intermediate mold section 4 correspondingly to the shape of ejector plate 26.

[Method of Sealing and Molding Electronic Component with Resin]

First, substrate 5 mounted with electronic component 6 is supplied to substrate supply portion 8 provided on mold surface 2a of upper mold section 2 (or prescribed position of mold surface 4a of intermediate mold section 4 closer to upper mold section 2) while resin material 13 is supplied into pot 10 of lower mold section 3, which in turn is moved upward for closing mold 1 (upper, intermediate and lower mold sections 2, 4 and 3), as shown in FIG. 1.

At this time, electronic component 6 mounted on substrate 5 can be fitted and set in cavity 7 provided with top gate 9 at the center of cavity bottom surface 7b in intermediate mold section 4.

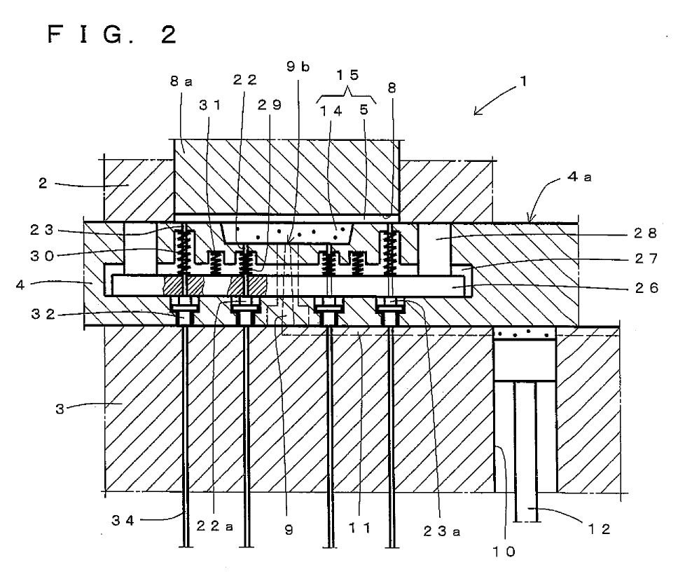

Then, heated/molten resin material 13 is pressurized with plunger 12 to be injected/charged into cavity 7 through runner 11 and top gate 9 (gate opening 9a and gate inlet 9b), as shown in FIG. 2.

After a lapse of a time necessary for curing resin material 13, molded product 15 consisting of resin compact 14 and substrate 5 can be formed by sealing and molding electronic component 6 mounted on substrate 5 with resin in resin compact 14 corresponding to the shape of cavity 7 in cavity 7.

At this time, each resin compact 14 is provided with resin (top gate resin 16) cured in top gate 9 and resin (runner resin 17) cured in lower mold section runner 11 connected to top gate resin 16, as shown in FIG. 7C.

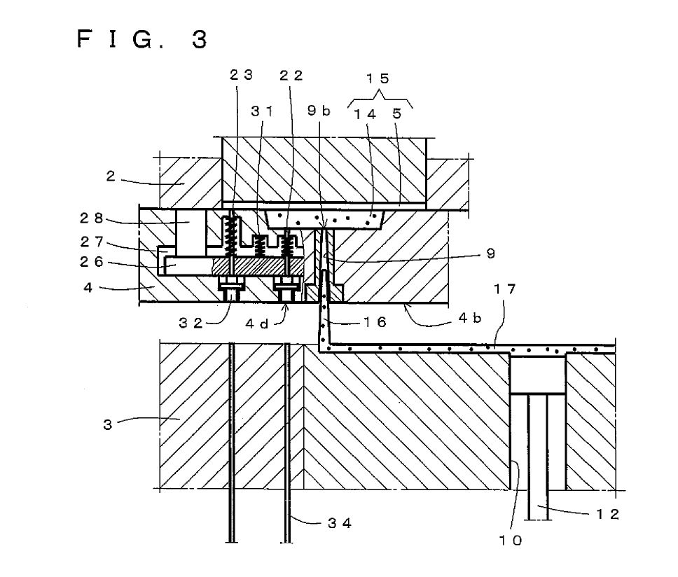

Then, lower mold section 3 is moved downward while runner resin 17 including top gate resin 16 is stopped/held in lower mold section runner 11, as shown in FIG. 3.

At this time, resin compact 14 and top gate resin 16 can be cut from each other along a joint closer to top gate resin 16.

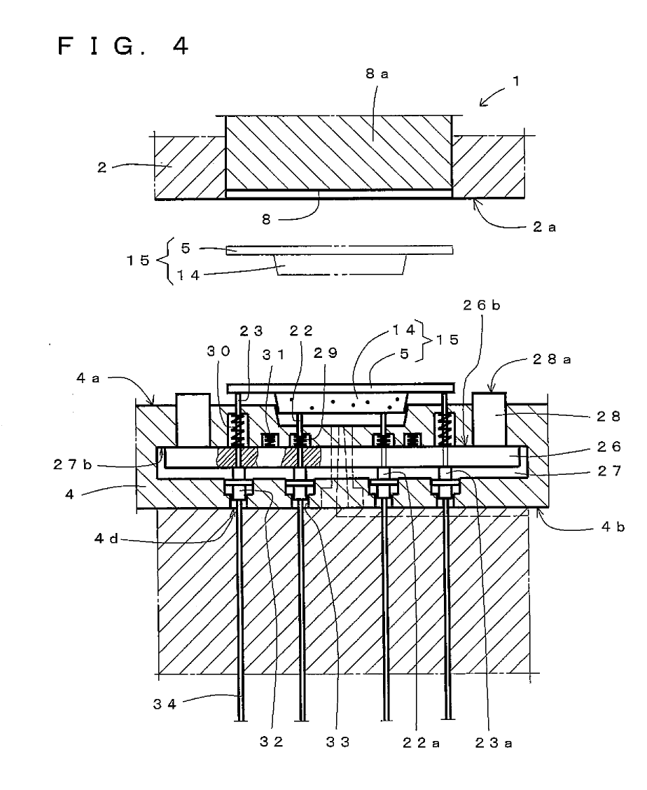

Then, upper mold section 2 and intermediate mold section 4 are opened while intermediate mold section 4 and lower mold section 3 are closed, and pressing members 34 are moved upward for operating molded product releasing mechanism 21, as shown in FIG. 4. Thus, mold releasing pins 22 and 23 can eject and release molded product 15 (consisting of resin compact 14 and substrate 5) from mold 1 (intermediate mold section 4).

[Mold Releasing Method With Molded Product Releasing Mechanism]

(Releasing of Molded Product)

As shown in FIG. 4, intermediate mold section 4 and lower mold section 3 are closed and pressing members (pressing pins) 34 provided on lower mold section 3 are moved upward, thereby pressing pressers 32 in stop sliding holes 33 with pressing members 34.

At this time, ejector plate 26 can be uniformly pressed (with uniform pressing force at a uniform speed) upward (in the ejective direction for mold releasing pins 22 and 23) by pressing lower surface 26a of ejector plate 26 with necessary number of pressers 32 (flange portions 32a) pressed by necessary number of pressing members 34 respectively.

At this time, further, ejector plate 26 can be efficiently moved upward in the parallelly held state without inclination, due to the upward guiding actions of return pins 28 fixedly provided on ejector plate 26.

Therefore, molded product 15 can be consequently ejected and released from mold 1 by ejecting and releasing resin compact 14 from cavity 7 with mold releasing pins 22 fixedly provided on ejector plate 26 while ejecting and releasing substrate 5 with mold releasing pins 23 fixedly provided on ejector plate 26.

(Return of Mold Releasing Pin)

As hereinabove described, mold 1 (molded product releasing mechanism 21) according to the present invention is provided with the return means elastically pressing ejector plate 26 downward (in the return direction) for returning mold releasing pins 22 and 23 to the return positions thereof.

As the return means, molded product releasing mechanism 21 has first elastic members 29 provided on the positions of mold releasing pins 22, second elastic members 30 provided on the positions of mold releasing pins 23 and third elastic members 31 provided between mold releasing pins 22 and 23 on ejector plate 26, as hereinabove described.

In other words, mold releasing pins 22 and 23 (ejector plate 26) are moved upward by upward pressing actions of pressing members 34 against downward returning actions of the aforementioned return means (elastic members 29, 30 and 31) in the aforementioned operation of upwardly ejecting/releasing molded product 15.

After molded product 15 is ejected and released with mold releasing pins 22 and 23, pressing members 34 are moved downward for canceling the upward pressing actions thereof. Thus, the aforementioned downward returning actions of the return means (elastic members 29, 30 and 31) are so revived that mold releasing pins 22 and 23 (ejector plate 26) can be returned to the return positions thereof.

At this time, ejector plate 26 can be moved downward in the parallelly held state without inclination due to the downward guiding actions of return pins 28.

Pressers 32 can be downwardly moved in stop sliding holes 33 by the own weights thereof (and additionally with heads 22a and 23a provided on lower surface 26a of ejector plate 26) by moving pressing members 34 downward, whereby pressers 32 can be stopped on stop step portions 33a through flange portions 32a thereof

(Return Action of Return Pin)

As hereinabove described, ejector plate 26 can be efficiently vertically moved in the parallelly held state without inclination by guiding the vertical movement of ejector plate 26 having the shape different from the general flat shape with the minimum necessary size by vertical regulation with return pins 28 sliding in sliding holes 35 in order to vertically move mold releasing pins 22 and 23 in the present invention.

Mold releasing pins 22 and 23 provided on mold 1 according to the present invention may cause defective sliding.

For example, mold releasing pins 22 and 23 may cause defective sliding in fitting holes 24 and 25 respectively, as shown in FIG. 6A.

At this time, the forward end of each mold releasing pin 23 and the forward end (forward end surface 28a) of each return pin 28 protrude from mold surface 4a of intermediate mold section 4 closer to upper mold section 2, while the forward end of each mold releasing pin 22 protrudes from bottom surface 7b of cavity 7.

In this case, mold surface 2a of upper mold section 2 is (relatively) pressed against forward end surface 28a of return pin 28 (by moving intermediate mold section 4 upward), as shown in FIG. 9B. Thus, forward end surface 28a of return pin 28 and the forward end of mold releasing pin 23 can be efficiently returned to mold surface 4a of intermediate mold section 4, while the forward end of mold releasing pin 22 can be efficiently returned to cavity bottom surface 7b.

(Functions/Effects)

As hereinabove described, ejector plate 26 can be effectively vertically moved (driven in the protrusive return direction for mold releasing pins 22 and 23) in the parallelly held direction without inclination due to the vertical guiding actions of return pins 28.

In other words, mold releasing pins 22 and 23 fixedly provided on ejector plate 26 can be guided in the vertical direction (in the protrusive return direction) and efficiently vertically moved with return pins 28 in normal molding with mold 1.

According to the present invention, therefore, mold releasing pins 22 and 23 can be efficiently vertically moved through ejector plate 26 due to the guiding actions of return pins 28 in normal molding with mold 1, whereby mold releasing pins 22 and 23 can be efficiently prevented from defective sliding.

According to the present invention, further, mold releasing pins 22 and 23 can be efficiently returned to the return positions through ejector plate 26 by (relatively) pressing return pins 28 with upper mold section 2 upon defective sliding of mold releasing pins 22 and 23.

According to the present invention, in addition, mold releasing pins 22 and 23 can be efficiently vertically moved due to the guiding actions of return pins 28 in normal molding with mold 1, while mold releasing pins 22 and 23 can be efficiently returned to the return positions by (relatively) pressing return pins 28 with upper mold section 2 upon defective sliding of mold releasing pins 22 and 23, whereby the productivity of the product (molded product 15) can be efficiently improved.

While a general ejector plate vertically moving mold releasing pins is in the form of a flat plate, mold 1 (particularly intermediate mold section 4 itself) equipped with ejector plate 26 according to the present invention is small-sized and hence ejector space portion 27 for receiving ejector plate 26 must be set to the minimum necessary size.

Ejector plate 26 must be formed in the minimum necessary size in order to set ejector space portion 27 to the minimum necessary size, and hence through-holes 36 etc. are provided on ejector plate 26 for eliminating an excessive space (volume).

In other words, ejector plate 26 is formed in the shape different from the flat shape, and the thickness thereof is reduced to about half the general level.

According to the present invention, further, the engraved portion (ejector space portion 27) for receiving ejector plate 26 having the shape different from the flat shape is set to the minimum necessary size.

Therefore, ejector space portion 27 freely receiving ejector plate 26 is formed by engraving intermediate mold section 4 correspondingly to the shape of ejector plate 26, and the mold member is freely fitted in through-holes 36 (36a, 36b and 36c).

The present invention is not restricted to the aforementioned embodiment, but the respective structures can be arbitrarily and properly changed and selected within the range of the subject matter of the present invention, if necessary.

(Another Ejecting/Releasing Method)

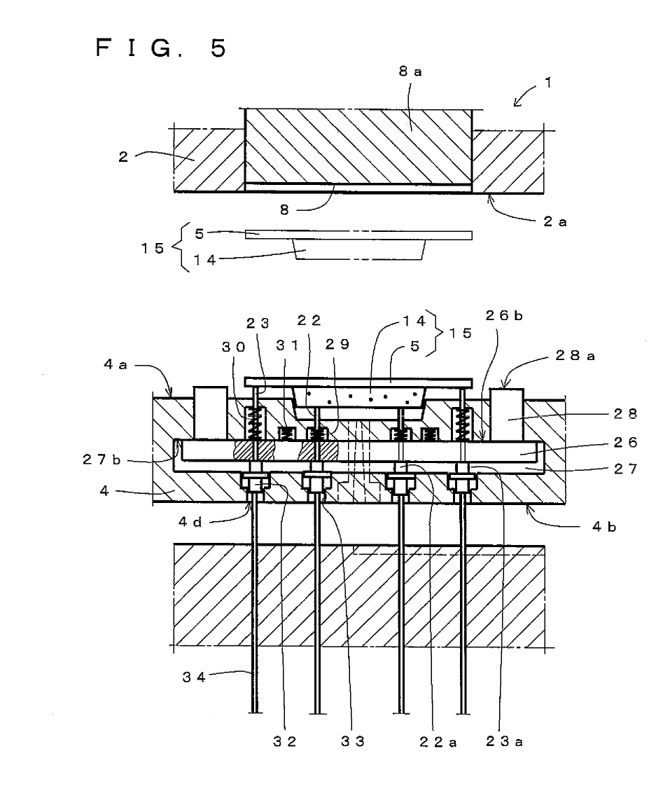

Another ejecting/releasing method different from that shown in FIG. 4 is described with reference to FIG. 5.

Referring to FIG. 5, pressing members 34 are pressed upward for moving mold releasing pins 22 and 23 upward while opening (separating) intermediate mold section 4 and lower mold section 3 after cutting resin compact 14 and top gate resin 16 from each other in FIG. 3.

Therefore, pressing members 34 are so pressed that molded product 15 (consisting of resin compact 14 and substrate 5) can be ejected and released by moving ejector plate 26 upward through pressers 32 and moving mold releasing pins 22 and 23 fixedly provided on ejector plate 26 upward, similarly to the aforementioned embodiment (see FIG. 4).

When the pressing with pressing members 34 is canceled, mold releasing pins 22 and 23 (ejector plate 26) are returned to the return positions thereof, similarly to the aforementioned embodiment.

Therefore, ejector plate 26 can be efficiently vertically moved (driven in the protrusive/returned direction for mold releasing pins 22 and 23) in the parallelly held state without inclination due to the vertical guiding actions of return pins 28 fixedly provided on ejector plate 26, similarly to the aforementioned embodiment.

Referring to FIG. 5, top gate resin (16) and runner resin (17) are removed from lower mold section 3.

(Structure of Another Ejector Plate)

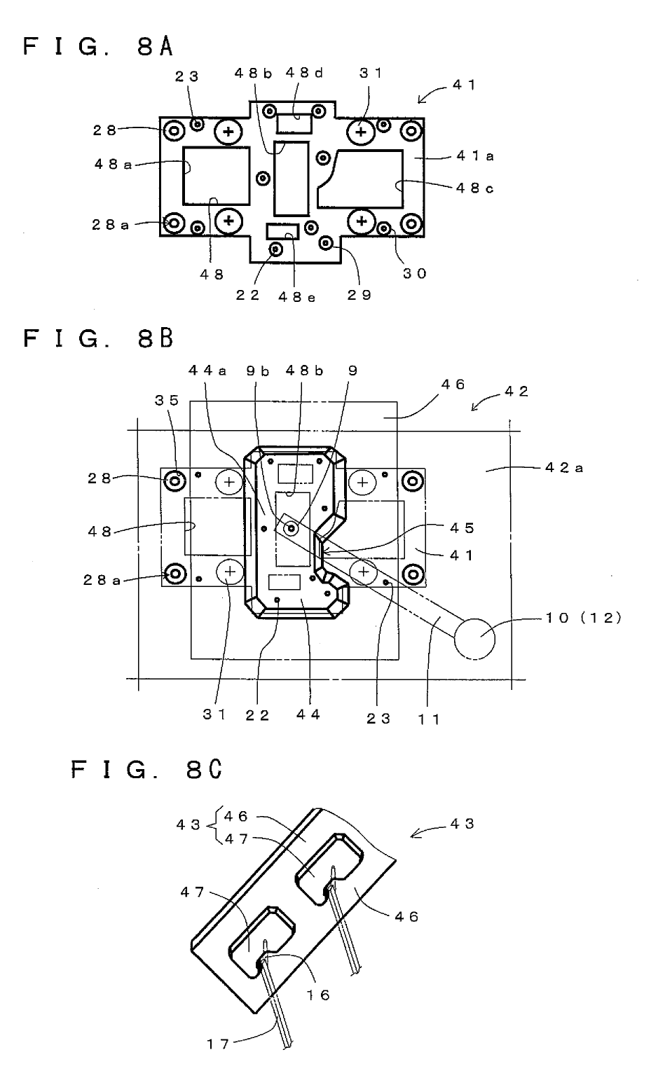

The structure of another ejector plate 41 according to the present invention is described with reference to FIGS. 8A, 8B and 8C.

FIG. 8A shows ejector plate 41 according to the present invention, FIG. 8B shows a mold (mold surface 42a of an intermediate mold section 42 closer to an upper mold section) provided with ejector plate 41 shown in FIG. 8A, and FIG. 8C shows a molded product 43 sealed/molded with resin in the mold (42) shown in FIG. 8B.

A reentrant cavity 44 for resin molding provided on mold surface 42a of intermediate mold section 42 shown in FIG. 8B has a dent portion 45 formed by denting part of a side of a cavity opening (or a cavity bottom surface 44a) inwardly into cavity 44, dissimilarly to a general rectangular cavity (cavity 7 shown in FIG. 7B, for example).

In intermediate mold section 42 shown in FIG. 8B, a mold top gate 9 (gate inlet 9b) is provided at the center of cavity bottom surface 44a. A mold runner 11 and a pot 10 (12) communicatively connected to mold top gate 9 are arranged on a side closer to dent portion 45 of cavity 44 than the center of cavity 44 (mold runner 11 is arranged on a lower right position in FIG. 8B).

In the mold (42) shown in FIG. 8B, a resin material heated/molten in pot 10 is pressurized with a plunger 12, to be injected/charged into reentrant cavity 44 through mold runner 11 and top gate 9. Thus, an electronic component mounted on a substrate 46 is sealed/molded in a resin compact 47 having dent portion 45 corresponding to the shape of reentrant cavity 44. Consequently, molded product 43 (consisting of substrate 46 and resin compact 47) shown in FIG. 8C is obtained (cavity plate 41, runner 11 etc. are shown by two-dot chain lines).

Referring to FIG. 8C, resin compact 47 having dent portion 45 is provided with top gate resin 16 and runner resin 17.

As shown in FIG. 8A, ejector plate 41 is provided with necessary through-holes (volume reducing portions) 48 (in order to reduce the volume of ejector plate 41). Ejector plate 41 is formed in a shape different from a flat shape, correspondingly to the shape of reentrant cavity 44.

Referring to FIG. 8A, ejector plate 41 is provided with five through-holes 48, i.e., a left through-hole 48a, a central through-hole 48b, a right through-hole 48c, an upper through-hole 48d and a lower through-hole 48e.

Further, an upper surface 41a of ejector plate 41 is provided with mold releasing pins 22 (first elastic members 29) corresponding to the shape and the position of reentrant cavity 44 and mold releasing pins 23 (second elastic members 30) corresponding to the shape and the position of substrate 46, similarly to ejector plate 26 in the aforementioned embodiment.

Further, third elastic members 31 are provided between mold releasing pins 22 and 23 on upper surface 41a of ejector plate 41, similarly to the aforementioned embodiment.

In addition, four return pins 28 are fixedly provided on four corners of upper surface 41a of ejector plate 41, similarly to the aforementioned embodiment.

Ejector plate 41 exhibits functions/effects similar to those of ejector plate 26 in the aforementioned embodiment.

Therefore, return pins 28 can guide mold releasing pins 22 and 23 through ejector plate 41, similarly to the aforementioned embodiment. Further, mold releasing pins 22 and 23 can be efficiently prevented from defective sliding in normal molding with the mold. In addition, mold releasing pins 22 and 23 and ejector plate 41 can be returned to return positions thereof by relatively pressing return pins 28 with the upper mold section upon defective sliding of mold releasing pins 22 and 23.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A method of sealing and molding an electronic component with resin for forming a molded product by sealing and molding an electronic component mounted on a substrate with a mold for sealing and molding an electronic component with resin consisting of a first mold section, a second mold section and an intermediate mold section provided between said first and second mold sections by injecting and charging a heated and molten resin material into a cavity for resin molding provided in said intermediate mold section, comprising the steps of:
ejecting and releasing necessary portions of said molded product from said mold with a necessary number of mold releasing pins fixedly set on an ejector plate provided on said intermediate mold section and pressed toward said second mold section by pressing said ejector plate with a pressing member provided on said second mold section through a presser provided on said intermediate mold section in molding with said mold;
elastically pressing said ejector plate and returning said ejector plate to a return position by canceling the pressing with said pressing member in molding with said mold; and
guiding said mold releasing pins in a protrusive or returned direction with a return pin fixedly provided on said ejector plate in molding with said mold.

2. The method of sealing and molding an electronic component with resin according to claim 1, further comprising the step of returning said mold releasing pins to return positions by pressing said return pin with said first mold section upon defective sliding of said mold releasing pins.

3. A mold for sealing and molding an electronic component with resin including a first mold section, a second mold section opposed to said first mold section, an intermediate mold section provided between said first and second mold sections and a cavity for resin molding provided on a mold surface of said intermediate mold section closer to said first mold section, comprising:
an ejector plate provided at said intermediate mold section;
a necessary number of mold releasing pins fixedly provided at said ejector plate;
a presser provided at said intermediate mold section for pressing said ejector plate in an ejective direction;
a pressing member provided at said second mold section for pressing said ejector plate through said presser;
an elastic member returning said mold releasing pins to return positions;
another elastic member returning said ejector plate to a return position; and
a return pin guiding said ejector plate and said mold releasing pins in a protrusive or returned direction.
